(19) United States
(12) Patent Application Publication
(10) Pub. No.: US 2009/0032516 A1
(43) Pub. Date: Feb. 5, 2009

(54) Warming bag, pajama warmer

(76) Inventor: Lance George Reasor, Duluth, MN (US)

Correspondence Address: Lance George Reasor, 130 E. 9th Street, Duluth, MN, 55805, US

(21) Appl. No.: 12/220,962

(22) Filed: Jul. 30, 2008

Related U.S. Application Data
(60) Provisional application No. 60/962,440, filed on Jul. 30, 2007.

(51) Int. Cl. H05B 1/00; H05B 3/34; B65D 33/16; B65D 33/00

(52) U.S. Cl. 219/201; 219/529; 219/549; 383/61.3; 383/105

(57) ABSTRACT

The technical nature of this invention is the development of a flexible bag, which has a flexible-reflective interior foil that is protected from being damaged by the objects to be placed inside the bag for warming such as fabric items, gloves, pajamas, baby clothes, or construction materials that need to be kept warm. Items are kept warm by a heating pad which is plugged into a standard 120 volt outlet or into a 12 volt DC converter. The bag is portable or can be left in a location where the warmed items need to be used. In industrial or construction applications, the addition of a strap to the bag allows it to be easily carried or hung over a railing for easy dispensing of the items that are being kept warm in the bag. The bag retains heat for an extended period of time when unplugged.

### CROSS REFERENCE

This application claims priority from Provisional Application No. 60/962,440 filed on Jul. 30, 2007.

### STATEMENT REGARDING FEDERALLY SPONSORED RESEARCH OR DEVELOPMENT

Not Applicable

### PARTIES IN JOINT RESEARCH

Not Applicable

### IN REFERENCE TO SEQUENCE LISTING

Not Applicable

### BACKGROUND OF THE INVENTION

This invention was created to fulfill the need for a low cost, low energy, heat retaining fabric bag that is portable and can be used for warming and heating a number of items, primarily pajamas, gloves, socks, baby clothes, baby wipes, lubricants, construction cartridges, construction materials such as tile, cans of foam, window and door sealing tape, grease cartridges, construction adhesives, or any of a number of smaller objects that need to be kept warm for either comfort, convenience, or utility purposes in cold weather.

There is no information known to the inventor or references that would relate to this invention.

Objective: Use a low power source to create a contained heat source that is captured and reflected back to the items to be warmed by reflective-flexible foil material. This warming bag is a low cost flexible means of warming items place in the bag with its thermostatic controlled heating pad. The warming bag is made gathering by fabric with an outer shell, flexible reflective foil lining and a satin or similar inner liner and sewing it into the form of a bag with a hole in the lower corner for the power cord and a flap at the top with a cord for fastening to one of the two buttons used for closing the bag. The second button is for reducing the height of the bag when the flap is folded over. The construction of the bag is done by stitching on all three sides of the bag other than the opening with the stitching interrupted for the opening on the lower corner for the exit of the power cord only. Stitching also secures the lining onto the flap by stitching on all three sides of the flap capturing the outer fabric, the reflective foil and the inner lining.

After investigation by the inventor, it is determined that there are no other inventions that exist that accomplish this heating task in the same manner.

### BRIEF SUMMARY

A fabric bag constructed with a flexible reflective interior foil, captured between different types of fabric which will contain an electric heating pad designed to fit inside the bag and uses a low amount of energy to keep items that are placed inside the bag warm. This bag is easy to use and has open and close flap and easily accepts items of various sizes and nomenclature. The exterior fabric is designed to be appealing to the eye and thoughtfully constructed to make it easier for the user. This invention makes it easy for someone to have warm items at the point of use if electricity is available within the reach of the power cord with an on/off switch. The warming bag solves the need to seek alternative means of warming those items which are desired to warmed such as pajamas, baby clothes, baby wipes, gloves, socks, construction adhesives and sealants. Techniques used up to this point have been clothes dryers, microwave ovens, ovens, wood burning stoves or any other heat source one could find applicable to the situation.

### BRIEF DESCRIPTION OF SEVERAL VIEWS OF THE DRAWING

FIG. 1a is a front view of the bag.

Item 1 is the fabric outer covering.

Item 2 are the buttons used to secure the cord (item 3) which is secured through the eyelet (item 5) in the flap and shows the electrical cord with on/off switch (item 4).

FIG. 1b shows the front view of the bag with the flap open including the cord opening (item 7).

FIG. 2a is the back view of the bag showing the cord opening (item 7) and also the bottom view indicating thickness of the bag which is 9/16″-3″ when gusseted.

FIG. 2b shows the back of the bag with the flap open and a top view of the bag with the securing loop (item 3) and the decorative button (item 2).

FIG. 3a is a perspective view of bag closed showing the cord (item 4) with plug and on/off switch with the decorative buttons (item 2) used for securing the bag closed with cord (item 3) and the eyelet (item 5).

FIG. 3b is a perspective showing the bag open with the decorative buttons (item 2) securing cord (item 3) and the bag outer shell (item 1).

FIG. 4a is the exploded view showing the fabric outer shell (item 1), the buttons (item 2) used for closure, the flexible-reflective foil inner shell (item 9), the inner satin lining (item 8), the heating pad (item 10) and, again, the inner satin lining (item 8), the flexible-reflective foil (item 9) and the outer shell (item 1).

FIG. 4b is a cut-away view showing the outer material (item 1), the flexible-reflective foil (item 9), the inner satin lining (item 8) and the heating pad (item 10).

FIG. 5a is the construction detail, a side view showing the outer shell material (item 1), the flexible-reflective foil (item 9), inner satin lining (item 8) and the heating pad (item 10).

FIG. 5b shows the construction detail showing the side band stitching (item 11), which is on the left, right and bottom on the interior of the bag showing, the banding material (item 11) covers the raw edges of the components of the bag.

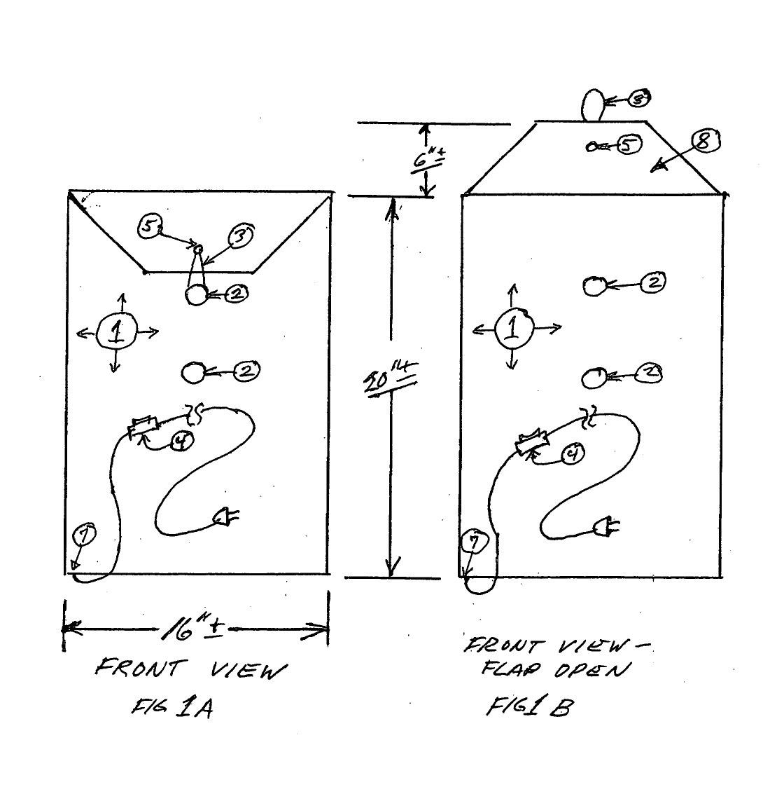

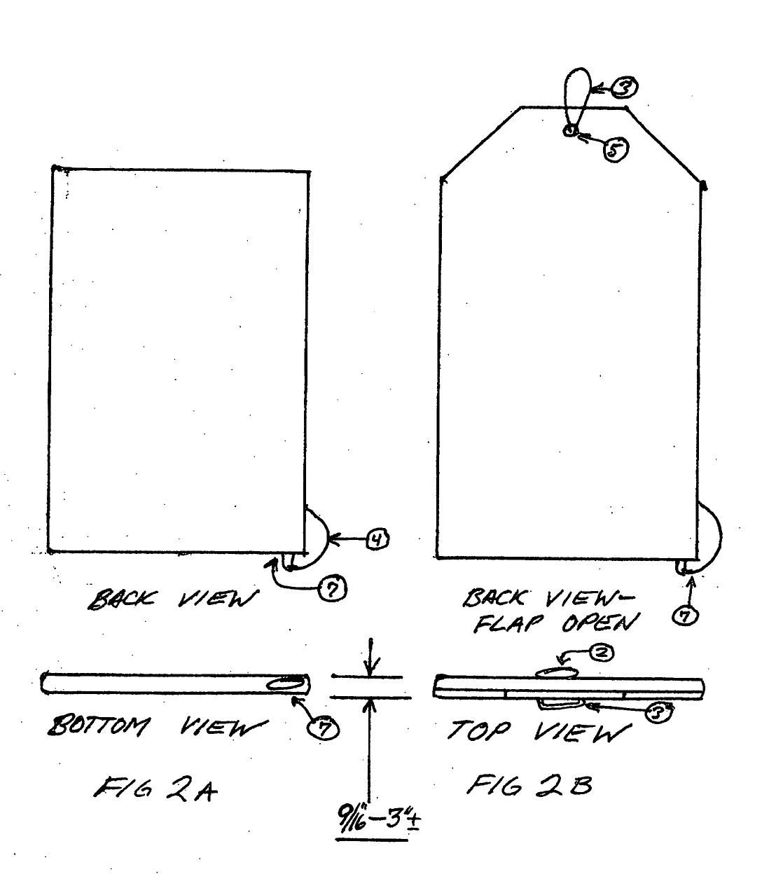

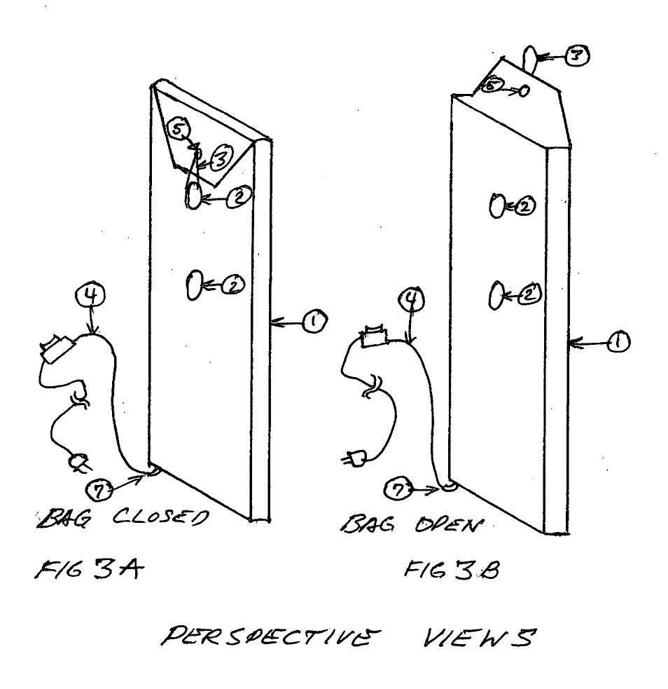

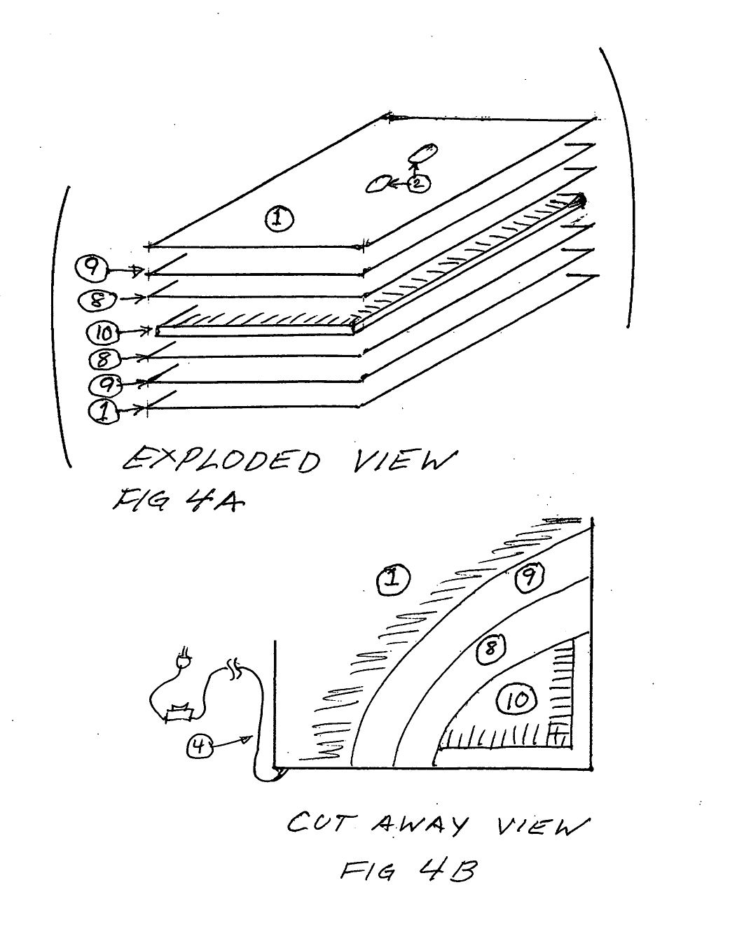

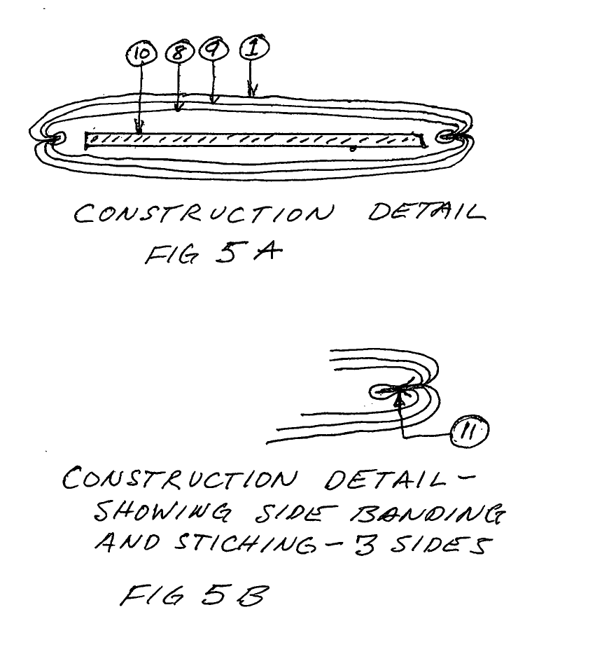

### DETAILED DESCRIPTION OF THE INVENTION

The bag is manufactured by taking the components of the bag, cutting all the outer fabric, reflective foil, and inner lining to the same size and with the components in reverse order (inside out), all three layers are stitched together, (top, bottom and side) using the covering material to cover the seam. Stitching will take place along the left, bottom, and right side and also include stitching on the edges of the flap, punching a hole for the grommet, placing the ¼″ twisted satin cord through the grommet, creating a loop to go over the decorative button closure. The button stitching is through to the inside of the bag for greater anchoring and securing. When stitching is complete, including the eyelet hole and the bottom corner, or other locations as may be necessary, the bag is turned right side out. Any additional straps or pockets, or closure devices would be secured (stitched) to the bag prior to assembling the front and back of the bag to the other layers. The bag may also contain an inner zippered pouch for holding the heating pad if the warming bag is applied for different uses requiring the securing of an inner bag. The bag would be used by placing any item that was desired to be warmed on either side of the heating pad, turning on the switch and closing the flap to the bag.

### DISTINCT CLAIM

The distinct claim of the warming bag is that the flexible-reflective foil captured between an outer protective shell and an inner lining will reflect the low amount of heat created by the heating pad, retain it in the bag, reflect it back into the bag while using this small amount of heat to warm any object that is placed in the bag and will continue to capture the heat allowing the smallest amount of heat possible to escape the bag. Thereby, requiring less energy and retaining for a longer period than a standard insulated bag might do. The reflective is the reason for the low energy consumption and the high heat retention in the bag. The bag creates a contained atmosphere.

I claim:

1. A fabric bag with a flexible-reflective foil material on both the front and back of the bag captured between an inner lining and outer shell with a heating pad placed in the center, so items to be heated or warmed can be placed on either side the heating pad and the bag can be closed with the cord looped over either one of the two buttons sewn on the front of the bag.

2. The bag described in claim 1 shall be capable of having an inner zippered bag containing the heating element to make it more desirable for inserting and removing items without disturbing contact with the center heating element, and the center bag shall have a zipper for easy replacement of the inner heating pad, should it require replacement.

3. The bag in claim 1, closure on the bag may be a Velcro hook and loop type closure for securing the flap when such closure is more desirable to industrial type application.

4. The bag in claim 1, outer shell may have a sewn pouch of sufficient size to store the cord for the heating pad with a Velcro closure on the opening end for containing the cord when the bag is being moved.

5. The bag in claim 1 can be constructed, whereby, outer shell may contain a small Velcro type hook and loop pad for attaching the on/off switch to the side of the bag in proximity of the opening for the cord to connect the heating pad.

6. The bag in claim 1 can be constructed, whereby, a cord opening at the upper end of the bag to protect the cord from abrasion when contact with various surfaces the bag might be set on could cause damage.
